(19) United States
(12) Patent Application Publication
(10) Pub. No.: US 2002/0187558 A1
(43) Pub. Date: Dec. 12, 2002

(54) Method for determining the amount of metal in water and kit therefor

(75) Inventors: Joseph B. Bodkin, State College, PA (US); Hubert L. Barnes, State College, PA (US)

Correspondence Address: Hubert L. Barnes, 213 East Mitchell Ave., State College, PA, 16803-3655, US

(73) Assignee: Advanced Exploration & Research, Inc., State College, PA

(21) Appl. No.: 09/874,567

(22) Filed: Jun. 5, 2001

(51) Int. Cl. G01N 21/00

(52) U.S. Cl. 436/164; 436/80; 436/84; 436/81; 436/77; 436/83; 436/161; 436/178; 422/61

(57) ABSTRACT

The present invention is a colorimetric method, and kit therefore, for determining the level of elemental contaminants in a water source. In a preferred embodiment, the method comprises: (a) sampling a discrete amount of water to be tested, (b) contacting the water sample with a solid material having high specificity for reversibly binding to, or complexing with, the element to be detected, (c) separating the element-containing solid from the water sample, (d) eluting the element from the element-containing solid with an eluting solution, (e) adding a cation-containing solution capable of freeing the element to be detected from the eluting compound, (f) adding a buffer, (g) adding a colorimetric material capable of indicating the amount of metal present in the solution, (h) adding an oxidation-fixing reagent, and (i) estimating the amount of metal in the sample by comparing the solution to provided color standards. The invention is particularly useful as a kit for applying the method for testing home drinking water for lead content.

### FIELD OF THE INVENTION

This invention relates to a method and apparatus for detecting elemental contaminants, and in particular, heavy metal contaminants in water. More specifically, the invention relates to a colorimetric water testing kit for determining the amount of metal in a water sample at concentrations as low as the parts per billion level.

### BACKGROUND OF THE INVENTION

Contamination of the environment has been increasing steadily for years as the use of metals, chemicals, pesticides, and bacterial organisms has increased. Even though the toxicity of various elements has been known for centuries, it is only recently that there has been a serious increase in interest in minimizing human exposure to their compounds. Current public awareness of such pollutants and their associated hazards has created a consumer demand for products that are capable of determining the presence of, or concentration of, unwanted and potentially dangerous solutes including metals.

Some of the more toxic metals include lead, cadmium, mercury, barium, chromium and beryllium. Lead, in particular, has been subject to much attention due to its presence in fuels, articles or paints commonly found in the home, and especially because of its common occurrence in drinking water.

Lead occurs in drinking water primarily as a corrosion by-product of the materials used in residential plumbing systems. Water leaving the water treatment plant is typically relatively lead-free. However, pipes and solder containing lead are readily corroded by water, especially soft and acidic water, and lead levels at the domestic user's tap can be much higher than those found at the treatment plant. Although the deleterious health effects of ingested lead have been known for centuries, lead piping is commonplace in older residences, particularly those located in the eastern United States. While most newer homes now have galvanized steel, PVC plastic, or copper plumbing, until very recently the copper plumbing was joined by use of lead-tin alloy solder. It is now well recognized that newly-installed solder is easily dissolved, and people living in new housing, or in older housing but with new plumbing, wherein copper connections have been made with lead-tin alloy solder, are especially at risk of high levels of lead in the drinking water. While solder of this composition is no longer widely used, millions of homes still have lead-soldered plumbing. In addition to these risks, brass fittings may also be leached of contained lead.

Because of the serious problems presented by lead contaminated drinking water, a method is needed by which the average homeowner can simply and inexpensively test tap water to semi-quantitatively determine the level of dissolved lead present. To address this and other needs, a number of methods have been created for detecting the occurrence of metals, including lead, in solids and liquids. One well-known qualitative test for lead together with certain other metals, such as copper, bismuth, and antimony, consists of adjusting the pH to the region of about 0 to 2 and bubbling in hydrogen sulfide gas. If lead is present in sufficient quantity, a black precipitate (lead sulfide) is formed. Similarly, in a known prior art method of detecting lead in paint, sodium sulfide (Na₂ S) is reacted with lead to form the black precipitate—lead sulfide (PbS) thus confirming the presence of lead. This method has several disadvantages: (1) the sodium sulfide is potentially toxic, especially to young children; (2) the black precipitate is difficult to see on dark surfaces; (3) the sodium sulfide releases highly poisonous and volatile hydrogen sulfide (H₂S), which has a noxious odor; and (4) the reagents react with many additional cations to form black precipitates and thus tend to give false readings on many surfaces.

It is also known that amounts of lead on the order of four to seven parts per million can be determined by using dithizone or various instrumental methods. However, such tests require special equipment and chemicals, and often involve complicated experimental procedures. This type of test cannot easily be conducted by average persons in their own premises.

Another common analytical reagent is a metal-complexing agent, rhodizonic acid. For over forty years, rhodizonic acid, and salts thereof, have been used as analytical reagents to detect heavy metals, including lead, in both qualitative and quantitative analyses. The methodology for using rhodizonate dye is based on two types of tests:

(1) a quantitative determination of heavy metals in solutions using a spectrophotometer to obtain quantitative information; and

(2) qualitative determinations which use filter papers impregnated with the reagent.

In addition, semi-quantitative information can be derived from the use of columns packed with silica gel impregnated with rhodizonate dye.

An example of the use of rhodizonate dye in a colorimetric method for the specific determination of a substance such as lead in a liquid can be found in: “A Simple Direct Estimation of Ultramicroquantities of Lead in Drinking Water Using Sodium Rhodizonate”by E. Jungreis and M. Nechama, Microchemical Journal, vol. 34, pp. 219-221 (1986). This article describes a test which can only detect lead in amounts above about fifty parts per billion. This test involves a number of steps, including preparation of a reagent test strip, heating a solution to dryness and development of the test spots. The reagents used include nitric acid and hydrochloric acid, which are hazardous and not available or widely used by the average person.

In another example, the Macherey-Nagel Company (Duren, Germany) manufactures a test paper for the determination of lead under the trademark PLUMBTESMO. The PLUMBTESMO strips comprise a heavy filter paper with a reagent impregnated therein. To test for lead in a solution, a strip is dipped into the solution, and observed for a color change that indicates the presence of lead. These strips can also be used to detect lead deposits in motor vehicle tailpipes. The strips suffer from several disadvantages. First, the chemicals on the strips rub off on the user's hands and clothes after the reaction takes place, causing contamination of other surfaces and requiring constant clean-up. Second, when attempting to use the strips in solutions, other metals interfere with the reaction, potentially causing false results when testing for lead.

Some methods that address the need for testing for metal contamination are also mentioned in US and foreign patent applications. Some representative examples include: U.S. Pat. No. 3,809,537 to Horine; U.S. Pat. No. 4,786,604 to Michael; and U.S. Pat. No. 4,125,376 to Razulis.

Horine describes a technique for testing lead leached from pottery. This test involves extracting lead from the suspect pottery in an acid medium and reacting the resulting solution with an aqueous solution of sodium sulfide to produce an indicator precipitate of lead sulfide.

Michael describes a detector kit for testing lead concentrations in excess of approximately 5 parts per million. The kit uses a sodium or potassium chromate solution. This test has the disadvantage of not being able to detect lead at concentrations in the parts per billion range.

The patent issued to Razulis, discloses a test for various organic and inorganic water contaminants using a test tube with a small cube of synthetic sponge that is saturated with an indicator compound. For inorganic metal salts, the foam cube is impregnated with a solution of dithizone. A change in color of the cube indicates the presence of the salts of various heavy metals such as chromium, cobalt, lead, mercury and zinc in the water being tested. Lead chromate, thiocyanate, and sulfate were detected by a change in color of the cube from bright green to pinkish gray at a limit of 200 micrograms/liter (parts per billion). This test cannot distinguish among the heavy metals and thus is prone to error when trying to determine the concentration of a single metal.

Despite the various methods described above for detecting metals in a convenient manner, detection of metals (and lead in particular) in water is generally accomplished by sending a sample to a testing laboratory where the metal content of the sample is determined by analytical instrumental methods, such as atomic absorption spectroscopy, inductively coupled plasma mass spectrometry, or anodic stripping voltammetry. These instrumental methods are expensive and require sophisticated users.

For example, one method advanced for detecting trace metals in liquid samples involves preparation of a liquid sample, oxidation of organic matter in the sample by boiling with potassium persulfate, treatment of the sample with ammonium pyrrolidinecarbodithioate, filtering the sample and then analyzing the sample by x-ray spectrometry. This process, described in Tisue et. al., “Preconcentration of Submicrogram Amount of Metals from Natural Waters for X-ray Energy Spectrometric Determination Using Pyrrolidinecarbodithioic Acid”, Anal. Chem., 57:82-87 (1985), is inaccessible to the average person because the particular equipment required is not available. Moreover, the x-ray spectrometry is extremely sensitive to contaminant metals that may be introduced by the oxidizing agent. In this case, ultra-pure chemicals must be manufactured in order to avoid contamination. Finally, the test described in Tisue et. al. requires heating the persulfate in order to oxidize the organic matter in the sample, which is disadvantageous in a home use test.

A different method of detecting trace metals in liquid is described in Lo et. al., “Solvent Extraction of Dithiocarbamate Complexes and Back-Extraction with Mercury(II) for Determination of Trace Metals in Seawater by Atomic Absorption Spectrometry”, Anal. Chem., 54:2536-2539 (1982). This procedure involves the extraction of metal-dithiocarbamate complexes into chloroform followed by back-extraction with a dilute mercury solution This method involves extremely hazardous chemicals and requires monitoring and controlling the pH levels of each solution utilized. Moreover, this method is not available to the average person due to the complexity of the process, the chemicals used, and the equipment needed to conduct the x-ray spectrometry.

These types of analytical methods of water testing for pollutants require wet chemical analytical techniques utilizing trained personnel to perform even the most routine analysis. The wet chemical analysis methods are costly and suffer from a number of disadvantages. These disadvantages result from the time consuming and often complicated additional steps used in preliminary separation and preparation of the test sample. The processing often includes a number of procedural steps such as concentration of the test sample, filtering, adjusting the pH and adding one or more reagents. The results obtained by these methods thus depend on (1) the technique and experience of the analyst, with knowledge of chemistry and/or training being required, and (2) the strict control of laboratory procedures including measurement of reagents. For the above reasons, the wet chemical analytical techniques have had no practical application to on-site testing of water samples.

In summary, exposure to heavy metals continues to be a matter of concern. In particular, exposure to lead in drinking water needs to be minimized, regardless of whether the lead is in source water or is from corrosion of plumbing materials,. Typically, analysis for heavy metals is carried out in certified laboratories. However, such an analysis does not provide an immediate answer, cannot be conducted on site, requires preservation of a sample for later analysis, requires a high level of technical expertise to conduct, and is expensive. Thus there is a need in the industry for a simple, inexpensive, accurate, and timely test or method for determining the presence of metal contaminants in water.

A number of attempts have been tried to address this long felt need. However, a completely effective and simple test for lead or other metals in liquid samples has not heretofore been developed. Additionally, none of the previously identified testing techniques are well suited for use in the home or in the field for testing the concentrations of metals in a water sample at the parts per billion level. These are the primary needs addressed by the present invention.

### SUMMARY OF THE INVENTION

The process and test apparatus of this invention has succeeded in providing simple procedures for on-site analytical tests for rapid, sensitive and specific identification of elements, including metals, dissolved in water. Moreover, the process of this invention can obtain more accurate and economical results than the prior art without the need for technically trained personnel.

A preferred application of the invention described herein fills the need for an improved lead test for drinking water by providing a simple, rapid and lead-specific test for aqueous lead in concentrations down to about five parts per billion. Additionally, the detection method of the invention will not give a false reading due to the presence of other common metallic ionic species in tap water, such as iron, zinc, or copper, or to other elements such as calcium and magnesium These are major advantages over prior art on-site testing methods.

An object of this invention is to provide a method for visual colorimetric determination of trace levels of elements in an aqueous sample.

Another object is to provide a method that is simple to use, provides quick results and is cost-effective.

Another object of the invention is to provide a kit that is safe to dispose of, and provides an improved method for colorimetrically analyzing for trace levels of heavy metals.

It is another object of the present invention to provide an improved method for testing water for metal contamination both economically and with high accuracy and selectivity.

Yet another object of the present invention is to provide a water testing method and kit that can determine the concentrations of a predetermined metal at levels in the low parts per billion range.

Still another object of the present invention is to provide a convenient water testing method that can be used in the home or in the field and provides a high degree of accuracy that previously was available only through expensive lab analysis.

Another more specific object of the present invention is to provide a simple, easy-to-use water testing kit that homeowners can use to test their drinking water for lead content.

These and other objects are achieved by the present invention, which is a method for testing water for metal content. The invention also includes a kit for conveniently performing the method in the home or in the field.

Generically, the method comprises the following steps wherein “metal” can be a metal or other target element:

a) sampling a discrete amount of water to be tested;

b) contacting the water sample with a solid composition having high specificity for reversibly binding to, or complexing with, the metal to be detected;

c) separating the solid containing the target metal from the water sample;

d) eluting the metal from the metal-containing solid with an eluting solution;

e) adding a cation-containing solution to free the metal from the eluant complex;

f) adding a buffer to control pH and to complex excess cations,

g) adding a material capable of forming a colored complex to indicate the amount of metal present in the solution;

h) adding an oxidation-controlling regent to stabilize the ferric ions, and

i) estimating the amount of metal in the sample by comparing properties of the solution to a provided set of color standards.

With the foregoing and other objects, advantages and features of the invention that will become hereinafter apparent, the nature of the invention may be more clearly understood by reference to the following detailed description of the preferred embodiments of the invention and to the appended claims.

### DETAILED DESCRIPTION OF THE INVENTION

The first step in the method of the present invention is to collect a water sample. The sample collection can be for any water where it is desired to know the level of a specific trace metal or other element. Typical applications for the method include: (1) detecting the amount of lead, or other selected metal, contained in a home drinking water source, and (2) detecting the amount of trace metals in streams to assist in locating underground sources of mineral ores. The method of collecting the sample, except to avoid adding a contaminating target element, is not critical. However it is important to collect a known amount of sample so that the level of metals can be determined when comparing the results with the provided color standards. Again, the specific amount of sample collected is not critical, but there are tradeoffs. In a preferred implementation of the invention, a vial or bottle is provided in a water testing kit that allows the user to collect approximately 1 liter of water sample. This amount can be increased resulting in an increase of processing time and a higher sensitivity of the test. The amount can be decreased to shorten the processing time, but this would also decrease the sensitivity of the test.

Once the sample is collected, the next step of the method requires that the sample be contacted with a compound that selectively and reversibly binds or complexes with the metal to be detected. By “selective,” it is meant that the compound has a dominant preference for binding or complexing with the target element or metal as opposed to other elements, which might also be present in the sample. Preferably, the selective compound binds or complexes substantially only with the target element or metal. This is a significant improvement of the present invention over the prior art methods that are not specific to certain metals. These prior art methods have reduced accuracy because other metals in addition to the target metal bind or complex with the complexing agent.

What is meant by selective binding can also be put into quantitative terms. To be selective for the present invention, preferably at least 90%, more preferably at least 95%, of the metal ions that the complexing agent complexes must be the target metal where the metal concentrations are within the ranges typical of drinking waters. Most preferably the specificity is greater than 99%.

Specific examples of complexing agents that bind selectively are the macrocyclic polyethers. Macrocyclic polyethers (crown ethers) are a generation of chelating agents that can be used for selective separation of metal ions based on the ionic radius-cavity size compatibility concept. These compounds are capable of selectively forming complexes with a variety of different cationic species (see Izatt et al., Chem. Rev. 85:271 (1985), Bajaj et al., Coord. Chem. Rev. 87:55 (1988) and Lamb et al., Journal of Chromatography 482:367-380 (1989)). These compounds are referred to as “crowns” because their chemical structures resemble the shape of the regal crown and because of their ability to “crown” cationic species by complexation. The ability of a crown ether molecule to complex with a cation is dependent upon the size of the hole formed by macrocyclic structure and, as a result, crown ethers of different sizes exhibit significantly different specificities for the complexation of cations (see Buschmann et al., Journal of Solution Chemistry 23(5):569-577 (1994)). For example, some crown ethers readily form complexes with sodium ion but are incapable of effectively complexing with potassium ion, other crown ethers effectively complex with lead, cesium or rubidium but not with calcium or lithium. The cation complexation characteristics of many crown ether molecules have been well documented in the literature (e.g., see Hiraoka, “Crown Ethers and Analogous Compounds”, Elsevier Science Publishers, Amsterdam, (1992) and Buschmann et al., (1994) supra). Further, by modifying the crown structure with negatively charged functional groups to a macrocycle host, the selectivity and efficiency for metal ion complexation can be improved. This attached functional group can be used to differentiate cations of similar sizes with different chemical properties. The use of the term “crown ether” herein includes those crowns that contain, in addition to oxygen and carbon, other elements including sulfur and/or nitrogen in the crown ring.

Some of the preferred compounds are described in the following two articles: (1) J. S. Bradshaw et al. “Stable silica gel-bound crown ethers, selective separation of metal ions and a potential for separations of amine enantiomers”, Journal of Inclusion Phenomena and Molecular Recognition Chemistry, vol. 7, 127-136, (1989) and (2) R. M. Izatt et al., Thermodynamic and kinetic data for macrocycle interaction with cations and anions: Chemical Review vol. 91, 1721-2085 (1991). These compounds are also disclosed in the following U.S. Pat. Nos. 4,943,375; 4,975,379; 5,179,213; and 5,393,892. These patents and articles are hereby incorporated by reference. It is also noted that these compounds are commonly bound to a matrix through a hydrocarbon-Si(X₂)O—matrix group as taught by these patents. X is selected from alkyl, aryl alkoxy and other groups.

Some examples of crown ethers include the following:

TABLE 1
Examples of Crown Ethers and Related Compounds

| | |
|---|---|
| C₈H₁₇NO₃ | Aza-12-crown-4 |
| C₈H₁₈N₂O₂ | 1,7-Diaza-12-crown-4 |
| C₈H₂₀N₄ | Tetraazacyclododecane |
| C₁₀H₂₀N₄O₂ | 1,4-Dimethyl-1,4,7,10-tetraazacyclododecane-6,11-dione |
| C₁₀H₂₀O₅ | 15-crown-5 |
| C₁₀H₂₁NO₄ | Aza-15-crown-5 |
| C₁₀H₂₂N₂O₃ | 1,7-Diaza-15-crown-5 |
| C₁₀H₂₄N₄ | Tetraazacyclotetradecane |
| C₁₀H₂₄N₄ | 1,4-Dimethyl-1,4,7,10-tetraazacyclododecane |
| C₁₁H₂₂N₄O₂ | 1,4-Dimethyl-1,4,7,11-tetraazacyclotridecane-6,12-dione |
| C₁₁H₂₂N₄O₂ | 1,10-Dimethyl-1,4,7,10-tetraazacyclotridecane-3,8-dione |
| C₁₁H₂₂O₆ | 2-(Hydroxymethyl)-15-crown-5 |
| C₁₁H₂₆N₄ | 1,4-Dimethyl-1,4,7,11-tetraazacyclotridecane |
| C₁₁H₂₆N₄ | 1,10-Dimethyl-1,4,7,10-tetraazacyclotridecane |
| C₁₂H₁₆O₄ | Benzo-12-crown-4 |
| C₁₂H₂₄N₄O₂ | 1,11-Dimethyl-1,4,8,11-tetraazacyclotetradecane-3,9-dione |
| C₁₂H₂₄O₂S₄ | 1,4,7,10-Tetrathia-13,16-dioxacrown-6 |
| C₁₂H₂₄O₄S₂ | 1,4-Dithia-7,10,13,16-tetraoxacrown-6 |
| C₁₂H₂₄O₄S₂ | 1,10-Dithia-4,7,13,16-tetraoxacrown-6 |
| C₁₂H₂₄O₆ | 18-crown-6 |
| C₁₂H₂₅NO₅ | Aza-18-crown-6 |
| C₁₂H₂₆N₂O₄ | 1,10-Diaza-18-crown-6 |
| C₁₂H₂₆N₂O₄ | 1,7-Diaza-18-crown-6 |
| C₁₂H₂₈N₄ | 1,11-Dimethyl-1,4,8,11-tetraazacyclotetradecane |
| C₁₃H₂₆O₇ | 2-(Hydroxymethyl)-18-crown-6 |
| C₁₄H₂₀O₅ | Benzo-15-crown-5 |

A preferred crown ether for detecting lead in water, is the compound known as Pb02 supplied by IBC Advanced Technologies, Inc., American Fork, Utah. These and other crown ether compounds are commercially available. These compounds are also known as molecular recognition technology. The skilled artisan can readily determine the appropriate compounds to use once the target element or metal has been determined by optimizing the size of the “hole” of the macrocyclic ether with the size of the target element.

The specific method of contacting the water sample with the solid complexing agent is not critical except that it is important for essentially the entire sample to contact the complexing agent and for them to be in contact with one another for a length of time sufficient for substantially all of the target metal to be bound or complexed. The amount of time necessary is variable but typically a few tens of minutes, depending on the flow rate and the surface area of the complexing agent. In a preferred embodiment, the inventors have found that allowing the sample to gravity feed at about 40-50 ml/min through a section of a column, tube, or permeable disk packed with a granular form of the solid complexing compound provides sufficient exchange of the metal (e.g. lead) from the sample onto the solid complexing compound.

The form of the complexing agent is also not particularly limited except for the need to provide sufficient contact with the sample to complex with substantially all of the target metal. In a preferred embodiment, the solid complexing agent is a crown ether coating a support material. The support helps to increase the surface area per unit mass of the complexing agent available to bind with the target element. Support materials are well known to those skilled in the art. Some non-limiting examples include silica, glass, zeolites, polymers, and ceramic materials. In a specific example of the present invention the crown ether is bonded to silica grains.

After the sample has been in contact with the complexing agent, the target metal will be selectively bound or complexed with the complexing agent. Because the complexing agent of the present invention is selective, the contaminant metals that are not the target metal will not be complexed and will remain in solution. After the complexing agent has been in contact with the water sample for a sufficient amount of time, the processed water sample is separated from the complexed material for rejection. Any means of physically separating the processed water sample from the solid retaining the target element or metal can be used. Such methods are well known in the art. In the present invention the simplest and most economical means are desirable with filtration being the preferred method. Further, in a preferred embodiment of the invention the solid complexing material is packed in a column and inherently acts as a filter as the sample flows through the column. After the complexed material and the processed sample solution have been separated, the processed solution can be discarded.

The next step in the process is to elute the complexed target metal from the solid complexing compound. Any reagent that uncomplexes the target metal from the complexing agent can be used in this step as long as it does not interfere with the later processing of the solution. In a preferred embodiment the eluting material is a solution that is used to flush the column containing the complexed material. Compounds that make good eluting materials in the present invention include amino polycarboxylic acids. Representative examples include cyclohexanediaminetetraacetic acid CDTA, nitrilotriacetic acid (NTA), ethylenediaminetetracetic acid (EDTA), hydroxyethylethylenediaminetriacetic acid (HEDTA), diethylenetriaminepentaacetic acid (DTPA), 1,2-diaminopropanetetraacetic acid (1,2-PDTA), 1,3-diaminopropanetetraacetic acid (1,3-PDTA), and 2,2′-ethylenedioxybisethyliminodi(acetic acid) (EDEA). The preferred eluting material in the lead testing embodiment of the invention is a CDTA solution. The amount and concentration of the elutin solution is not particularly limited as long as the amount of elutin compound is in stoichiometric excess and is sufficient to elute substantially all of the target metal. These parameters are optimized to remove the target metal from the complexing compound. In a preferred embodiment of the invention, a kit is supplied which provides an eluent in an amount of about 1 to 100 ml, preferably about 5 to 20 ml. After the eluting solution has been in contact with the solid complexing material for a length of time sufficient to elute substantially all of the target element, the eluent and the solid can be separated and the original solid complexing compound can be discarded.

After eluting the target metal the eluent will contain the target metal complexed with eluting compound plus uncomplexed eluting material. Next in the process is to free the metal ions so that they become reactive to combine with an indicator compound. The inventors have found ferric compounds to be the most effective compounds for this purpose, especially in a preferred embodiment of testing water for lead content. Any compound capable of producing ferric ions in solution and that does not interfere significantly in the later processing of the solution is suitable. In the lead testing embodiment of the invention, the preferred compound is ferric nitrate and a less beneficial alternative is ferric acetate. The amount of the ferric compound added is preferably stoichiometric, or at slight stoichiometric excess above the amount of eluting compound added. It is even more preferable that the amount of ferric ions produced by the ferric compound be stoichiometrically equal to that of the eluting compound so that no excess ferric ions are left in solution. After adding the ferric compound, the target metal is substantially in free ionic form in the solution. While ferric compounds are used in the preferred embodiment of testing for lead contents, other ions may be necessary in testing for other elements. A person skilled in the art can determine which compounds can be used to free the target metal ions so that they become reactive to combine with an indicator compound.

Next, an optional buffer solution is added to control the pH of the solution and to also bind any excess ferric ions that may be present in the solution. Potentially any buffer material known to those skilled in the art and which does not significantly interfere with the remainder of the process can be used. The inventors hereof have found that a combination of sodium citrate and sodium borate is an effective buffer. Preferably an amount of buffer is added to maintain the pH in the region of 6.5 to 9.5 and most preferably in the range of 7 to 8.5. Even more preferred, the pH is maintained at about 7.5. Also, it should be noted that the buffer material can be added prior to, or concurrently with, the indicator material.

The next addition to the solution is a colorimetric indicator compound capable of combining with the free target metal ions and capable of giving varying densities or tints of colors indicative of the amount of target metal in solution. Preferred indicator compounds are colorimetric compounds that produce different colored solutions based on the amount of target element or metal. The exact compound used is not particularly limited as long as the compound is capable of indicating the level of the target compound in some way. The colorimetric compound used in a preferred embodiment of the invention is pyridylazoresorcinol (PAR). The amount of the colorimetric compound that is added is designed so that it produces a color change over the range of detection that is of interest. To some extent, the specific colorimetric compound will depend on the target element or metal. Some examples of dye-type materials that are known to be good colorimetric materials for specific metals are discussed in U.S. Pat. No. 5,912,180 to M. Stone. This patent is hereby incorporated by reference.

An optional, but advantageous oxidizing agent can also be added at this time to stabilize ferric ions from reacting too quickly with the colorimetric compound. Suitable oxidizing agents are known to those skilled in the art. A preferred oxidizing agent is potassium nitrate. Other oxidizing agents may be more appropriate in different implementations of the invention. However, it is important that the oxidizing agent not detrimentally affect the colorimetric agent to any significant degree. The skilled artisan can readily determine an appropriate oxidizing agent and concentration without undue experimentation.

The final step in the invention method is to compare the solution resulting after addition of the indicator compound with a series of provided color standards. For example, in a preferred embodiment for testing for lead content in water using PAR as the indicator compound, the following colors indicate the given level of lead in parts per billion:

| | |
|---|---|
| Yellow | ˜0 ppb |
| Orange-Yellow | ˜5 ppb |
| Orange | ˜10 ppb |
| Reddish or Rose | ˜15 ppb |
| Red | >15 ppb |

These color standards were determined beforehand using samples of known lead content which are matched by supplied colored objects, such as paint spots, for color interpolations.

In one specific implementation of the kit according to the present invention, the column comprises a packed polymer tube containing a connector on one end. The connector is designed to be attached to the sample collection device (e.g. 1-liter plastic bottle). To begin the test, the bottle is filled with sample water, the tube/column is screwed onto the top of the bottle and the bottle is turned upside down to allow the sample to gravity feed through the column The eluting solution can also be used in a similar manner.

The invention will now be described with respect to a specific example of the invention.

### EXAMPLE

In step 1 of the process, a 1-liter sample of water containing lead at the EPA threshold is obtained. The sample characteristics are as follows: weight of lead-15 micrograms, concentration-7.24×10⁻⁸ molal, concentration-15 parts per billion. The sample is allowed to flow through a column containing a diazo 18-crown-6-ether on silica grains. The sample flow time through the crown ether is approximately 20 min/liter. The characteristics of the silica-bound, lead-selective crown ether include: weight-0.3 gm, grain diameter-150-250 microns (69-100 mesh), capacity-1-3×10⁻⁴ moles Pb/g crown ether, bed thickness-1.1 cm, and column diameter-0.9 cm. The initial head of sample solution above the top of the crown ether was 11.5 cm. The water sample was discarded after processing through the column.

Step 2 consisted of recovery of the lead from the crown ether material. The column was washed with a CDTA solution (cyclohexanediaminetetraacetic acid) having the following characteristics: concentration-0.0015 molal, volume-10 ml, moles-1.5×10⁻⁴, and flow rate of approximately 30 sec/10 ml. The eluent solution was collected and the column was discarded.

The result of step 2 was an approximately 10 ml solution containing CDTA and essentially all of the lead in the original sample. Step 3 was to cause release of the lead from the CDTA aqueous complex. To accomplish this, a ferric nitrate nonahydrate solid was added in an amount of 7.2 mg or 1.0×10⁻³ moles.

Step 4 consisted of adding a pH buffer, colorimetric indicator and reaction stabilizer. The modified citrate buffer added contained sodium citrate dihydrate, weight-0.29 gm, 1.0×10⁻³ moles and sodium borate decahydrate, weight-0.05 gm, 1.31×10⁻³ moles. The indicator compound added was PAR (monosodium 4-2 pyridylazo-resorcinol), weight-0.2 mg, 7.84×10⁻⁷ moles and the reaction inhibitor was potassium nitrate, weight-0.05 gm, 1.0×10⁻⁴ moles. The indicator reaction time was 5 min, at which time the color was read and compared to the provided standards. Solution indicator colors for comparison with standards supplied for 5, 10, and 15 ppb: yellow=0 ppb lead; reddish orange=15 ppb lead; red=30 ppb lead. (The change is gradational allowing some interpolation between the standards.) The color that resulted from this example was a reddish orange indicating a lead content in the 1-liter sample of water of about 15 ppb.

Although only preferred embodiments are specifically illustrated and described herein, it will be appreciated that many modifications and variations of the present invention are possible in light of the above teachings and within the purview of the appended claims without departing from the spirit and intended scope of the invention. Specifically, while only a specific crown ether compound and a single target metal have been demonstrated the skilled artisan can readily extend this work to other crown ether target element combination using the guidance disclosed herein.

We claim:

1. A method for determining the amount of a specific element in a water sample comprising:
a) sampling a discrete amount of water to be tested;
b) contacting the water sample with a solid material having high specificity for reversibly binding to, or complexing with, the element to be detected;
c) separating the element-containing solid from the water sample;
d) eluting the element from the element-containing solid with an eluting solution;
e) adding a solution containing cations to free the element from the elution complex;
f) adding a buffer to control pH and to complex excess cations,
g) adding a colorimetric material capable of indicating the amount of the element present in the solution; and
h) estimating the amount of element in the sample by comparing the solution to provided color standards.

2. The method of claim 1 comprising the additional step of adding an oxidation state-controlling reagent after, or concurrently with, adding the colorimetric material.

3. The method of claim 1 wherein the solid material having high specificity for reversibly binding to, or complexing with, the element to be detected is a macrocyclic crown ether.

4. The method of claim 3 wherein the macrocyclic crown ether is diazo 18-crown-6-ether coating a supporting substrate.

5. The method of claim 1 wherein the element to be detected is selected from the group consisting of: antimony, arsenic, bismuth, cadmium, chromium, cobalt, copper, lead, nickel, mercury, selenium, tin, and zinc.

6. The method of claim 1 wherein the contact with the solid material having high specificity for the element to be detected and used for separating the element from the water sample is accomplished by causing the sample to flow through a column, tube, or permeable disk containing the solid material.

7. The method of claim 1 wherein the eluting solution comprises a compound selected from amino-polycarboxylic ligands.

8. The method of claim 1 wherein the cation-containing solution is a solution containing ferric ions.

9. The method of claim 8 wherein the cation-containing solution comprises ferric nitrate.

10. The method of claim 1 wherein the buffer is added in an amount sufficient to provide the solution with a pH of from 6.5 to 9.5.

11. The method of claim 10 wherein the buffer is selected from the group consisting of sodium citrate, sodium borate, and combinations thereof, and wherein the pH of the solution after adding the buffer is from about 7 to 8.5.

12. The method of claim 1 wherein the material capable of indicating the amount of metal present in the solution is a pyridylazoresorcinol colorimetric agent.

13. A method for measuring the amount of lead in a water sample comprising
a) sampling a discrete amount of water to be tested;
b) contacting the water sample with a crown ether-containing material which forms a complex with lead in the sample;
c) separating the water sample from the crown ether, lead-complexed material;
d) eluting the lead from the crown ether, lead complex with a solution containing an amino polycarboxylic acid;
e) adding a ferric ion-containing solution;
f) adding a buffer to adjust the pH to the range of 7 to 8.5 and to complex any excess ferric ion;
g) adding a colorimetric agent;
h) adding an oxidation state-controlling solute; and
i) estimating the amount of lead in the sample by comparing the solution color to provided color standards.

14. The method of claim 13 wherein the crown-ether is a diazo-18-crown-6 ether attached to silica grains and is packed into a column, tube, or permeable disk through which the sample is poured.

15. The method of claim 13 wherein the amino polycarboxylic acid is CDTA, the buffer comprises a combination of sodium citrate and sodium borate, and the colorimetric agent is a pyridylazoresorcinol which is added in conjunction with the buffer material.

16. A water testing kit comprising
a) a compound which selectively binds to an element to be detected;
b) an eluting material;
c) a cation-producing compound capable of freeing the element from the eluting material;
d) a buffer and complexing agent; and
e) a colorimetric compound.

17. The kit according to claim 16 wherein the compound that selectively binds to the element to be detected is a macrocyclic crown ether.

18. The kit according to claim 17 wherein the macrocyclic crown ether is allylomethyl diaza-18-crown-6.

19. The kit according to claim 16 wherein the eluting material is an amino polycarboxylic acid.

20. The kit according to claim 16 wherein the cation-producing compound is ferric nitrate or ferric acetate.

21. The kit according to claim 16 wherein the buffer comprises a combination of sodium citrate and sodium borate and wherein the colorimetric compound is a pyridylazoresorcinol.

22. A water testing kit for estimating the amount of dissolved metal in a sample comprising
a) means for collecting a predetermined about of water sample
b) a column or tube containing a crown ether;
c) an amino polycarboxylic compound as an eluting material;
d) a ferric ion-producing compound;
e) a buffer material;
f) an effective amount of pyridylazoresorcinol as colorimetric compound; and
g) means for comparing the color of the processed sample with supplied color standards to estimate the amount of metal in the water sample.

23. The water testing kit according to claim 22 for detecting lead.

24. A water testing kit for detecting the amount of a specific metal in the low parts-per-billion level comprising a column, tube, or permeable disk packed with a crown ether containing solid material.
